(19) United States
(12) Patent Application Publication
(10) Pub. No.: US 2016/0334865 A1
(43) Pub. Date: Nov. 17, 2016

(54) APPLICATIONS OF SHAPE MEMORY POLYMERS ON AN INPUT DEVICE

(71) Applicant: Logitech Europe S.A., Lausanne (CH)

(72) Inventors: Samuel Siegfried, Lausanne (CH); Florent Berney, Lausanne (CH); Sandor Hoffer-Tóth, Modling (AT); Andreas Connellan, Dublin (IE); Cormac O'Conaire, Dublin (IE)

(21) Appl. No.: 14/714,020

(22) Filed: May 15, 2015

(51) Int. Cl. G06F 3/01; G06F 3/02; G06F 3/0354

(52) U.S. Cl. CPC G06F 3/01; G06F 3/03543; G06F 3/0202

(57) ABSTRACT

An input device including a housing, a cover plate, and a shape-memory polymer (SMP) disposed between the cover plate and the housing. The SMP being a rectangular flat lattice structure formed into a cylinder, the cylinder having a top portion and a bottom portion, where the top portion is coupled to the cover plate, and where the bottom portion is coupled to the housing. The SMP can be conformable at temperatures at or above a threshold value, and non-conformable at temperatures below the threshold value. The input device can include a heating element coupled to the SMP and configured to control the temperature of the SMP. The SMP can be comprised of a conductive ink formed of a density of conductive particulates, an etched conductor structure on a non-conductive substrate, or a conductive and stretchable yarn formed into a coil.

### CROSS-REFERENCES TO RELATED APPLICATIONS

The present U.S. Non-Provisional Patent Publication No. US 2014/0267040, filed on Mar. 15, 2013, and entitled “Input Device with a Customizable Contour,” is herein incorporated by reference in its entirety for all purposes.

### BACKGROUND

Input devices are ubiquitous in modern culture and are typically used to convert analog inputs (e.g., touches, clicks, motions, gestures, button presses, etc.) into digital signals for computer processing. An input device can include any device used to provide data and control signals to an information processing system such as a computer. Some non-limiting examples of input devices include keyboards, key pads, computer mice, remote controls, gaming controllers, joysticks, trackballs, and the like.

Input devices, such as computer mice, are conventionally designed for universal application. For example, different users may have different sized hands or left/right hand preferences, different design requirements, and different functional preferences. Thus, many manufacturers strive for one-size-fits-all designs to appeal to the greatest number of customers. Some manufacturers may offer specialized mice featuring certain specialty contours, features, and dimensions to appease the more discerning customers. However, customers are limited to the available designs, which may not satisfy their particular ergonomic preferences. Furthermore, even if a customer finds a comfortable design suited to a particular need, their preferences may change over time, or their ergonomic requirements may change for different applications (e.g., FPS gaming versus word processing). Moreover, sometimes different people in a household may use the same mouse.

Some contemporary designs include multi-paneled devices with customizable features that can be mechanically adjusted to user preference. However, these types of input devices are typically bulky, complex, highly specialized for particular tasks (e.g., FPS gaming), and are typically very expensive. Furthermore, their freedom of adjustment is typically limited to one or two dimensions, with each dimension of customization requiring complex mechanical hardware with bulky and awkward tuners for each adjustable panel. There is a need for a better customizable solution to adapt to any user's needs or evolving preferences.

### BRIEF SUMMARY

Shape memory polymers (SMPs) are malleable, conformable, and customizable materials that can be formed into a desired shape when the temperature of the SMP is heated above a threshold temperature and subsequently cooled to set the new configuration. The SMP can then be returned to the original shape with the reapplication of heat, as discussed in further detail below. In certain embodiments, SMPs are used to couple portions of an input device together to allow for three dimensions of unprecedented customizable control. For example, with the application of a stimulus (e.g., heat), a user can customize the height, pitch, tilt, and yaw of a palm region with respect to a housing of a computer mouse due to the unique deformable properties of the SMP (e.g., see FIG. 3A-4). The user can then return the position of the palm region to its original location or a new location using the same heating and cooling process. Aspects of the invention are focused on the deformable properties of SMP (e.g., the material and physical structure), the application of SMP technology on an input device (e.g., keyboard, computer mouse, or other suitable input device), and implementations of integrated heating systems in SMP-based devices (e.g., heating elements and power supplies).

Certain embodiments of the invention include a input device including a housing, a cover plate, and a shape-memory polymer (SMP) disposed between the cover plate and the housing. The SMP can be a substantially rectangular flat lattice structure formed into a cylinder, the cylinder having a top portion and a bottom portion. The top portion can be circular or elliptical and is coupled to the cover plate. The bottom portion can be circular or elliptical and is coupled to the housing. The SMP can be conformable at temperatures at or above a threshold value, and non-conformable at temperatures below the threshold value.

In some embodiments, the input device includes a heating element configured to control the temperature of the shape memory polymer. The heating element can be coupled to the SMP and may be comprised of one of a conductive ink formed of conductive particulates, an etched conductor structure having a two-dimensional spring configuration formed on a non-conductive substrate, or a conductive and stretchable yarn formed into a coil structure. The density of the conductive particulates can be any suitable value. After processing the ink traces consists of dense conductor, the electrical properties can be tuned by adjusting the trace geometry, trace length, trace width and trace thickness. The conductive particulates can be comprised of any suitable conductive element or compound, including but not limited to carbon nano tubes (CNT), graphene, silver flakes, silver nanowire, copper, and conductive polymers (e.g., “PEDOT”—poly 3,4-ethylenedioxythiophene). The etched conductor can be comprised of any suitable conductive element or compound including, but not limited to, copper, aluminum, or other suitable conductor. The non-conductive substrate can be comprised of any suitable non-conductive material including, but not limited to, a thermoplastic polyurethane.

In certain implementations, the cover plate of the input device can be one of a palm plate, a side plate, a knuckle plate, or a finger plate. The SMP can be coupled to the cover plate and housing by one of an adhesive (e.g., glue) or retaining device (e.g, clips, hardware, heat stake, or screw). The input device can be a computer mouse, remote control, touch pad, or similar input device.

In some embodiments, a keyboard includes a housing, a palm rest, and a shape-memory polymer (SMP) disposed between the palm rest and the housing. The SMP can be a substantially rectangular flat lattice structure formed into a cylinder having a top portion and a bottom portion. The top portion can be circular or elliptical and is coupled to the palm rest. The bottom portion can be circular or elliptical and coupled to the housing. The SMP can be conformable at temperatures at or above a threshold value, and non-conformable at temperatures below the threshold value.

In some embodiments, the input device includes a heating element configured to control the temperature of the shape memory polymer. The heating element can be coupled to the SMP and may be comprised of one of a conductive ink formed of conductive particulates, an etched conductor structure having a two-dimensional spring configuration formed on a non-conductive substrate, or a conductive and stretchable yarn formed into a coil structure. The density of the conductive particulates can be any suitable value. The conductive particulates can be comprised of any suitable conductive element or compound, including but not limited to, carbon nano tubes (CNT), graphene, silver flakes, silver nanowire, copper, and conductive polymers (e.g., PEDOT). The etched conductor can be comprised of any suitable conductive element or compound including, but not limited to, copper, aluminum, or other suitable conductor. The non-conductive substrate can be comprised of any suitable non-conductive material including, but not limited to, a thermoplastic polyurethane.

In certain implementations, the SMP can be coupled to the palm rest and housing by one of an adhesive (e.g., glue) or retaining device (e.g, clips, hardware, heat stake, screw, etc.) The keyboard can be part of a desktop computer, laptop computer, netbook, tablet computer, or other suitable input device that includes a palm rest or equivalent structure. In fact, aspects of the invention (i.e., the application of SMP structures) extend far beyond uses limited to mice and keyboards, including all input devices (e.g., adjust shape of remotes, smart phones, etc., to accommodate user's hand), vehicles (e.g., dashboards, steering wheel, seats (chair features in general), etc.), sports equipment (e.g., rackets, paddles, etc.), apparel (e.g., shoe features (e.g., inner sole to set heal height, front portion to set internal width of shoe), glasses (e.g., customize bridge, temple tips, nose pads, etc.), medical equipment (e.g., crutch handles/underarm pads, walkers, canes, etc.), grips on any handheld devices (e.g., utensils, weapons, etc.), or even to change the shape/look of enclosures (e.g., speaker housing, beverage container) for better grip. In each case, the modifications can be utilitarian (e.g., for ergonomic improvements), purely aesthetic for visual appeal, or a combination thereof. Those of ordinary skill in the art with the benefit of this disclosure would appreciate the unlimited number of ways the SMP technology described through this document could be applied outside the scope of an input device.

In further embodiments, a method includes forming a shape memory polymer (SMP) into a flat sheet, rolling the shape memory polymer into cylindrical shape, the SMP having a top portion and a bottom portion, coupling top portion to a cover plate of a input device, and coupling the bottom portion to a housing of the input device. The top portion can be coupled to the cover plate via an adhesive or retaining device, and the bottom portion can coupled to the housing via an adhesive or retaining device. The method can further include coupling a heating element to the SMP, where the heating element controls the temperature of the shape memory polymer. The heating element can be comprised of one of a conductive ink formed of a density of conductive particulates, an etched conductor structure having a two-dimensional spring configuration formed on a non-conductive substrate, or a conductive and stretchable yarn formed into a coil structure.

In some embodiments, a device includes a housing, a cover plate, and a shape-memory polymer (SMP) structure disposed between the cover plate and the housing, the SMP structure being a substantially cylindrical structure having a top portion and a bottom portion. The top portion is coupled to the cover plate and the bottom portion is coupled to the housing. The cylindrical structure can be circular, oval, polygonal, or any suitable shape. The SMP can be a three-dimensional (3D) printed structure, a flat structure configured into a cylindrical structure, or a combination thereof. In some cases, the SMP structure can be formed of a single coil. For example, the SMP structure can be wire-like (having any suitable gauge) and formed into a coil with a lattice structure, as shown in FIG. 13.

In certain embodiments, a device includes a housing, a cover plate, and a shape-memory polymer (SMP) disposed between the cover plate and the housing, the SMP formed in a flat disk-like structure with a plurality of cutouts therein. The disk-like structure has an outer portion and an inner portion, and the flat disk-like structure forms a plane. The inner portion is deformed in a direction normal to the plane and coupled to the cover plate, and the bottom portion is coupled to the housing.

In some implementations, a device includes a housing, a cover plate, and a shape-memory polymer (SMP) structure disposed between the cover plate and the housing, where the SMP structure formed in a collapsible tube-structure having an upper portion and a lower portion. The upper portion is coupled to the cover plate, and the bottom portion is coupled to the housing.

In further implementations, a device includes a housing, a cover plate having a top surface and a bottom surface, and a support structure having a first end and a second end. The first end of the support structure is coupled to the bottom surface of the cover plate, and the support structure protrudes at an angle substantially normal to the bottom surface of the cover plate. The device further includes a platform disposed in the housing, the platform having a top surface with a cavity formed therein. A shape-memory polymer (SMP) structure is coupled to the top surface of the platform, where a portion of the SMP structure is suspended over and crosses the cavity. The second end of the support structure is coupled to the suspended portion of the SMP structure.

Some embodiments include a second SMP structure coupled to the top surface of the platform, where a portion of the second SMP structure is suspended over and crosses the cavity such that both SMP structures intersect over the cavity, and where the second end of the support structure is coupled to the SMP structure at the intersection of both SMP structures.

### BRIEF DESCRIPTION OF THE DRAWINGS

FIG. 1 is a simplified schematic diagram of a computer system, according to certain embodiments of the present invention.

FIG. 2 is a simplified block diagram of a system configured to operate an input device, according to certain embodiments of the invention.

FIG. 3A is a simplified illustration of an input device with a palm plate coupled to its housing via a shape memory polymer (SMP), according to certain embodiments of the invention.

FIG. 3B is simplified illustration of an input device with a palm plate coupled to its housing via a shape memory polymer, according to certain embodiments of the invention.

FIG. 4 is an input device with a palm plate coupled to its housing via a shape memory polymer, according to certain embodiments of the invention.

FIG. 5 is a simplified flow diagram illustrating a method for forming a shape memory polymer for use on an input device, according to certain embodiments of the invention.

FIG. 6 is a simplified drawing that illustrates the concept of material strain, according to certain embodiments of the invention.

FIG. 7 is a deformation strain visualization of a shape memory polymer, according to certain embodiments of the invention.

FIG. 8 is a close up simulation visualization showing material strain on a shape memory polymer, according to certain embodiments of the invention.

FIG. 9 is a printed heating element on a stretchable non-conductive substrate, according to certain embodiments of the invention.

FIG. 10 is an etched conductive substrate on a non-conductive substrate, according to certain embodiments of the invention.

FIG. 11 is a conductive and stretchable yarn formed into a coil, according to certain embodiments of the invention.

FIG. 12 shows a non-limiting assortment of SMP lattice structures having various cross-hatched patterns, according to certain embodiments of the invention.

FIG. 13 shows an SMP structure in a wire-like form configured in a lattice structure having a cross-hatched pattern, according to certain embodiments of the invention.

FIGS. 14-17 provide examples of heating elements being etched directly on SMP, according to certain embodiments of the invention.

FIG. 18 illustrates a number of examples of SMP-based flexure mechanisms, according to certain embodiments of the invention.

FIGS. 19-20 illustrate an example of the use of SMP-based flexure mechanisms in an input device, according to certain embodiments of the invention.

FIGS. 21-22 illustrate the use of SMP-based strata structures in an input device, according to certain embodiments of the invention.

### DETAILED DESCRIPTION OF THE INVENTION

Embodiments of the invention are generally directed to input devices. More specifically, systems and methods for customizing and ergonomically improving an input device through the use of shape memory polymers.

In the following description, for purposes of explanation, numerous examples and details are set forth in order to provide an understanding of embodiments of the present invention. It will be evident, however, to one skilled in the art that certain embodiments can be practiced without some of these details, or can be practiced with modifications or equivalents thereof.

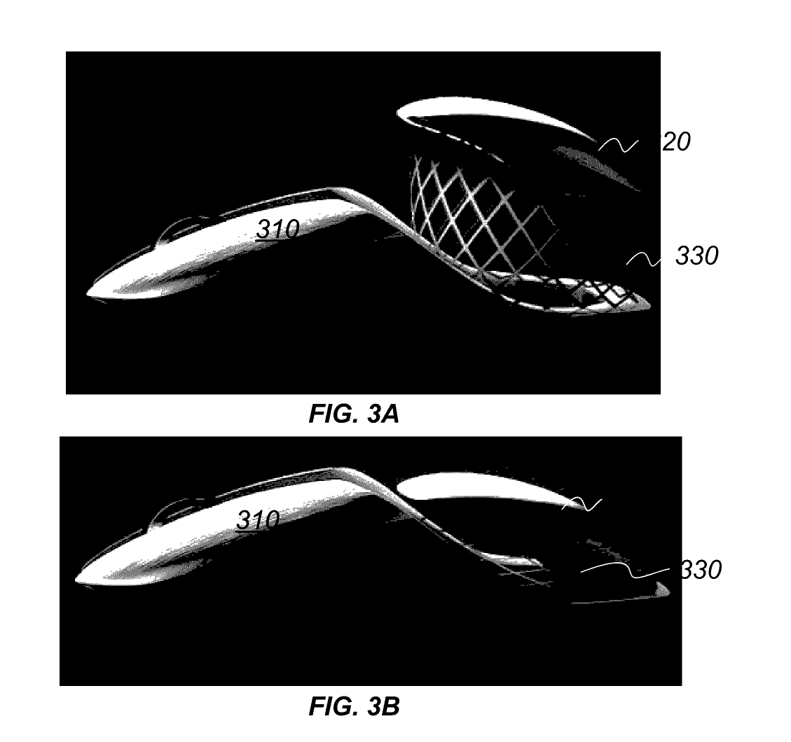

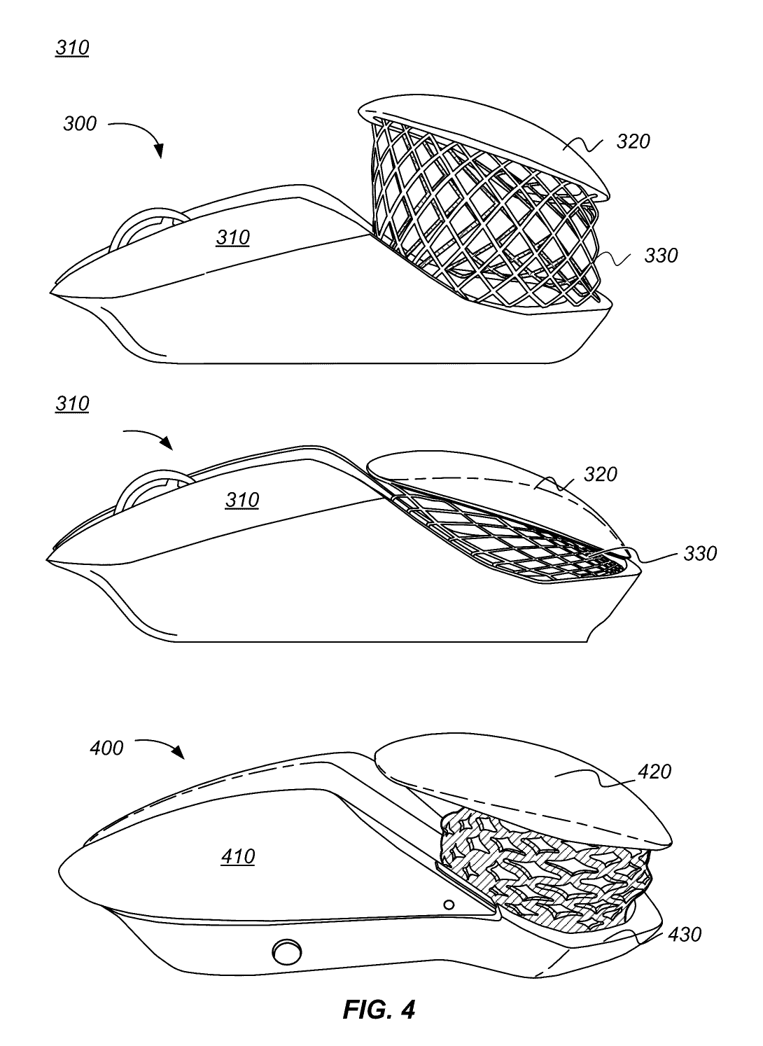

Shape memory polymers (SMPs) are malleable and customizable materials that can be formed into a desired shape when the temperature of the SMP is heated above a threshold temperature and subsequently cooled to set the new configuration. The SMP can then be returned to the original shape with the reapplication of heat, as discussed in further detail below. In certain embodiments, SMPs are used to couple portions of an input device together to allow for three dimensions of unprecedented customizable control. For example, with the application of a stimulus (e.g., heat), a user can customize the height, pitch, tilt, and yaw of a palm region with respect to a housing of a computer mouse due to the unique deformable properties of the SMP (e.g., see FIG. 3A-4). The user can then return the position of the palm region to its original location or a new location using the same heating and cooling process. Aspects of the invention are focused on the deformable properties of shape memory polymer structures, the application of SMP technology on a keyboard, computer mouse, or other suitable input device, implementations of integrated heating elements, and the control of the power supply in SMP-based devices. Thus, input devices using SMP technology can be highly configurable to accommodate any size hand, ambidextrous use, or grip style to make for highly functional universally applicability. Aspects of the invention (i.e., the application of SMP structures) can extend far beyond uses applied to mice and keyboards, including all input devices (e.g., adjust shape of remotes, smart phones, etc., to accommodate user's hand), vehicles (e.g., dashboards, steering wheel, seats (chair features in general), etc.), sports equipment (e.g., rackets, paddles, etc.), apparel (e.g., shoe features (e.g., inner sole to set heal height, front portion to set internal width of shoe), eye wear (e.g., customize bridge, temple tips, nose pads, etc.), medical equipment (e.g., crutch handles/underarm pads, walkers, canes, etc.), grips on any handheld devices (e.g., utensils, weapons, etc.), or even to change the shape/look of enclosures (e.g., speaker housing, beverage container) for better a grip. In each case, the modifications can be utilitarian (e.g., for ergonomic improvements), purely aesthetic for visual appeal, or a combination thereof. Those of ordinary skill in the art with the benefit of this disclosure would appreciate the unlimited number of ways the SMP technology described through this disclosure could be applied outside the scope implementations related to input devices.

Shape Memory Polymers

Shape-memory polymers (SMPs) can be polymeric smart materials (“polymer alloy”) that can return from a deformed or temporary state to an original shape when induced by an external stimulus, such as a temperature change. In some embodiments, SMPs can retain two or more shapes, and the catalyst to induce the transition between shapes may include certain temperature thresholds. Alternative embodiments may react similarly when exposed to certain light stimuli, electrical stimuli, magnetic fields, or chemical solutions.

Shape-memory polymers can include thermoplastic and covalently cross-linked (thermoset) polymeric materials. SMPs typically have both a temporary form and a permanent form. Once the permanent form has been manufactured by conventional methods, the SMP material can be changed into a different and temporary form by heating the SMP at or above a threshold temperature, deforming the SMP to a desired shape (e.g., applying a force to the SMP), and cooling the SMP below the threshold temperature. Thus, the SMP can maintain its temporary shape until activated by an external stimulus (e.g., temperature), which causes the SMP to revert back to its permanent form. In some cases, the heating/cooling system may have hysteresis, such that the cooling threshold temperature can be above or below the heating threshold temperature.

In addition to temperature, other activating stimuli may be used with certain types of SMP materials. For instance, light-activated shape-memory polymers (LASMP) use processes of photo-crosslinking and photo-cleaving to change a transition temperature. Photo-crosslinking may be achieved by using one wavelength of light, while a second wavelength of light may reversibly cleave the photo-cross-linked bonds, resulting in an SMP material that can be reversibly switched between an elastomer and a rigid polymer. In such cases, light activation changes the cross-linking density of the SMP. There are myriad SMP types that utilize a variety of different activation methods that may be used in the embodiments described herein, as would be understood by one of ordinary skill in the art.

Embodiments of the invention utilize SMP as a conformable link between two structural elements that can be germane to how you hold an input device. This can relate to a palm region, knuckle region, thumb region, finger region, or other region that contributes to the ergonomic comfort of the input device, be it a computer mouse, keyboard, remote control, gaming device, or the like. With respect to the embodiments described herein, SMP-based materials can be used to deform or reshape a contour of an input device per a user's ergonomic preference. SMP technology, as applied to input devices, can allow multiple users to utilize the same input device and enjoy the benefit of a customized body contour that can change to suit each user's needs. Various non-limiting embodiments of input devices using shape memory polymers and polymer alloys for customizable and deformable body contours are described herein.

System Architecture

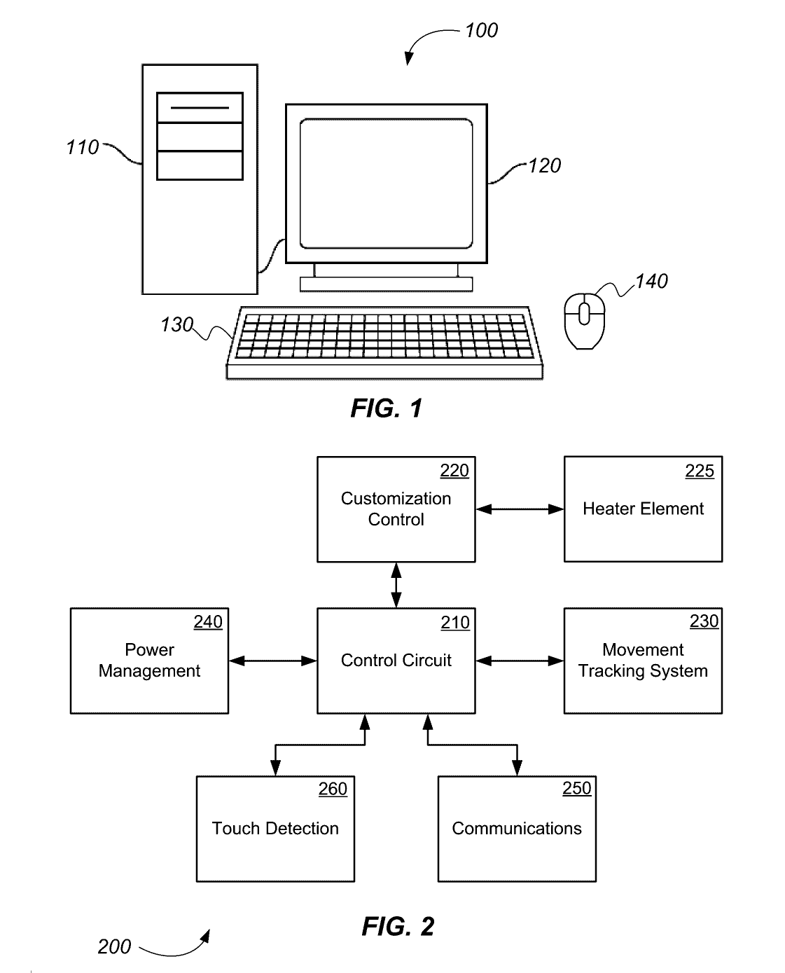

FIG. 1 is a simplified schematic diagram of a computer system 100 according to an embodiment of the present invention. Computer system 100 includes computer 110, monitor 120, keyboard 130, and an input device 140. In one embodiment, input device 140 can be a computer mouse, a remote control device, a game controller, a trackball, a track pad, a number pad, a touch sensitive device (e.g., tablet computer, personal digital assistant, media player, etc.), a mobile device, or any other suitable device that can be used to convert analog input signals into digital signals for computer processing. For computer system 100, input device 140 and keyboard 130 can be configured to control aspects of computer 110 and monitor 120.

In some embodiments, input device 140 can be configured to provide control signals for movement tracking (e.g., x-y movement on a planar surface, lift detection, etc.), touch/gesture detection, lift detection, orientation detection, power management methods, customization controls for ergonomic adjustments and contour customization, which is further discussed below, and a host of additional features that would be appreciated by one of ordinary skill in the art. Computer 110 may include a machine readable medium (not shown) that is configured to store computer code, such as mouse driver software, keyboard driver software, and the like, where the computer code is executable by a processor (not shown) of the computer 110 to affect control of the computer 110 by input device 140 and keyboard 130. The various embodiments described herein generally refer to input device 140 as a computer mouse, keyboard, or similar input device, however it should be understood that keyboard 130 and input device 140 can be any input/output (I/O) device, user interface device, control device, input unit, or the like.

FIG. 2 is a simplified block diagram of a system 200 configured to operate input device 140, according to certain embodiments of the invention. System 200 includes control circuit 210, customization control block 220, movement tracking system 230, power management system 240, communication system 250, and touch detection system 260. Each of the system blocks 220-260 can be in electrical communication with the control circuit 210. System 200 may further include additional systems that are not shown or discussed to prevent obfuscation of the novel features described herein.

In certain embodiments, control circuit 210 comprises one or more microprocessors (μCs) and can be configured to control the operation of system 200. Alternatively, control circuit 210 may include one or more microcontrollers (MCUs), digital signal processors (DSPs), or the like, with supporting hardware and/or firmware (e.g., memory, programmable I/Os, etc.), as would be appreciated by one of ordinary skill in the art. Alternatively, MCUs, μCs, DSPs, and the like, may be configured in other system blocks of system 200. For example, customization control block 230 may include a local processor to control the customization processes described herein (e.g., shape memory polymer control). In some embodiments, multiple processors may provide an increased performance in system 200 speed and bandwidth. It should be noted that although multiple processors may improve system 200 performance, they are not required for standard operation of the embodiments described herein.

Customization control block 220 may include one or more sub-systems that can be configured to control various aspects of the ergonomic systems and conformable region(s) that can be disposed on input device 140. For example, some embodiments may control the operation of a heater element 225 in a shape memory polymer (SMP) system, as further discussed below. Customization control block 220 may be a discrete system utilizing a local processing device, or may be integrated or subsumed in control circuit 210. Some or all of the customization control systems can be included in a single embodiment, or multiple embodiments, as required by design. The ergonomic systems and conformable regions that may utilize these control mechanisms are further discussed below.

Heater element(s) 225 can be coupled to one or more shape memory polymers (SMPs) on the input device. A heat element can directly or indirectly apply heat to the SMPs to control their temperature. Embodiments of the invention include one or more heater elements embedded or included in the input device such that no external heat source is required to control the deformation and setting of the SMP regions. Heater element(s) 225 can be user controlled and activated via a button, actuator, or other suitable control element to apply heat (e.g., beyond a predetermined threshold temperature) to the SMP to allow a user to deform the SMP to a desired configuration. In some embodiments, the heater element can be software controlled.

Movement tracking system 230 is configured to track a movement of input device 140, according to an embodiment of the invention. In certain embodiments, movement tracking system 240 can use optical sensors such as light-emitting diodes (LEDs) or an imaging array of photodiodes to detect a movement of input device 140 relative to an underlying surface. Input device 140 may optionally comprise movement tracking hardware that utilizes coherent (laser) light. In certain embodiments, one or more optical sensors are disposed on the bottom side of input device 140 (not shown). Movement tracking system 230 can provide positional data (e.g., X-Y coordinate data) or lift detection data. For example, an optical sensor can be used to determine when a user lifts input device 140 off of a surface and send that data to control circuit 210 for further processing.

In certain embodiments, accelerometers can be used for movement detection. Accelerometers can be electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. Accelerometers can further determine if input device 140 has been lifted off of a surface and provide movement data that can include the velocity, physical orientation, and acceleration of input device 140. In some embodiments, gyroscope(s) can be used in lieu of or in conjunction with accelerometer(s) to determine movement or input device orientation.

Power management system 240 can be configured to manage power distribution, recharging, power efficiency, and the like, for input device 140. In some embodiments, power management system 240 can include a battery (not shown), a USB based recharging system for the battery (not shown), power management devices (e.g., low-dropout voltage regulators—not shown), and a power grid within system 200 to provide power to each subsystem (e.g., accelerometers 220, gyroscopes 230, etc.). In certain embodiments, the functions provided by power management system 240 may be incorporated into the control circuit 210. The power source can be a replaceable battery, a rechargeable energy storage device (e.g., super capacitor, Lithium Polymer Battery, NiMH, NiCd), or a corded power supply. The recharging system can be an additional cable (specific for the recharging purpose) or it can use the mouse's USB connection to recharge the battery.

Communications system 250 can be configured to provide wireless communication with the computer 110, or other devices and/or peripherals, according to certain embodiment of the invention. Communications system 250 can be configured to provide radio-frequency (RF), Bluetooth, infra-red, or other suitable communication technology to communicate with other wireless devices. System 200 may optionally comprise a hardwired connection to computer 110. For example, input device 140 can be configured to receive a Universal Serial Bus (USB) cable to enable bi-directional electronic communication with computer 110 or other external devices. Some embodiments may utilize different types of cables or connection protocol standards to establish hardwired communication with other entities.

In some embodiments, touch detection system 260 can be configured to detect a touch or touch gesture on one or more touch sensitive surfaces on input device 140. Touch detection system 260 can include one or more touch sensitive surfaces or touch sensors. Touch sensors generally comprise sensing elements suitable to detect a signal such as direct contact, electromagnetic or electrostatic fields, or a beam of electromagnetic radiation. Touch sensors can be configured to detect at least one of changes in the received signal, the presence of a signal, or the absence of a signal. Furthermore, a touch sensor may include a source for emitting the detected signal, or the signal may be generated by a secondary source. Touch sensors may be configured to detect the presence of an object at a distance from a reference zone or point, contact with a reference zone or point, or a combination thereof. Certain embodiments of input device 140 may not utilize touch detection or touch sensing capabilities.

Various technologies can be used for touch and/or proximity sensing. Examples of such technologies include, but are not limited to, resistive (e.g., standard air-gap 4-wire based, based on carbon loaded plastics which have different electrical characteristics depending on the pressure (FSR), interpolated FSR, etc.), capacitive (e.g., surface capacitance, self-capacitance, mutual capacitance, etc.), optical (e g, infrared light barriers matrix, laser based diode coupled with photo-detectors that could measure the time of flight of the light path, etc.), and acoustic (e.g., piezo-buzzer coupled with some microphones to detect the modification of the wave propagation pattern related to touch points, etc.).

Although certain necessary systems may not expressly discussed, they should be considered as part of system 200, as would be understood by one of ordinary skill in the art. For example, system 200 may include a bus system to transfer power and/or data to and from the different systems therein. In some embodiments, system 200 may include a storage subsystem (not shown). A storage subsystem can store one or more software programs to be executed by processors (e.g., in control circuit 210). It should be understood that “software” can refer to sequences of instructions that, when executed by processing unit(s) (e.g., processors, processing devices, etc.), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations (e.g., shape memory polymer heater control, micro-pump control, mechanical blade control, etc.) as described herein.

It should be appreciated that system 200 is illustrative and that variations and modifications are possible. System 200 can have other capabilities not specifically described here (e.g., mobile phone, global positioning system (GPS), power management, one or more cameras, various connection ports for connecting external devices or accessories, etc.). Further, while system 200 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatuses including electronic devices implemented using any combination of circuitry and software. Furthermore, aspects and/or portions of system 200 may be combined with or operated by other sub-systems as required by design. For example, customization control block 220 may operate within control circuit 210 instead of functioning as a separate entity. Moreover, it should be understood that the various embodiments of conformable regions discussed herein can be of any size, shape, color, texture, etc., and can be applied to any input device (e.g., input device 140), with any suitable control infrastructure (e.g., system 200 including combinations and subsets thereof), at any preferred location and in any desired configuration. In addition, the inventive concepts described herein can also be applied to a keyboard, keypad, or other similar input device. For example, a wrist pad on a keyboard can include SMP to allow a user to control its ergonomic characteristics. The foregoing embodiments are not intended to be limiting and those of ordinary skill in the art with the benefit of this disclosure would appreciate the myriad applications and possibilities.

Exemplary Embodiments of SMP Lattice Structures

FIG. 3A illustrates an input device 300 configured to accommodate one or more SMP-coupled cover plates, according to an embodiment of the invention. Input device 300 can include a housing 310, a cover plate 320, and a shape memory polymer (SMP) mesh 330. SMP mesh 330 is a lattice structure that is very stiff and robust at room temperature, but deformable and compressible with a reasonable force at warm temperatures (i.e., threshold temperature). The SMP connection allows the cover plate to be customized in any configuration as often as desired with the application of heat beyond a threshold temperature. Input device 300 is shown in an uncompressed state.

Referring to FIG. 3A, SMP mesh 330 couples the cover plate to housing 310. In exemplary embodiments, SMP mesh 330 is a substantially rectangular flat lattice structure formed into a cylinder, as shown in FIG. 3A. The cylinder has a top portion and a bottom portion. The top portion and/or the bottom portion can be circular, elliptical, barrel shaped, or other suitable shape as would be appreciated by one of ordinary skill in the art. The top portion is coupled to cover plate 320 and the bottom portion is coupled to housing 310. SMP 300 can be coupled to housing 310, cover plate 320, or other structure by an adhesive, retaining device (e.g., latches, screws, etc.) or other suitable fastening or coupling methodology. Although cover plate 320 is shown as a palm plate, any number of cover plates can be used including, but not limited to, side plates, knuckle plates, finger plates, wrist supports, or any other desired customizable feature. Furthermore, FIG. 3A depicts an SMP-modified computer mouse, however input device 300 can include a keyboard, number pad, keypad (e.g., on a mobile smart device), joystick, or other preferred input device, as would be appreciated by one of ordinary skill in the art.

SMP 330 can be deformed and reshaped (e.g., reprogrammed, reset) in any suitable configuration, allowing a user to ergonomically customize any SMP-coupled cover plate as needed. That is, SMP is conformable when heated above a threshold temperature. For example, a user can customize the feel of input device 300 by configuring an SMP-coupled cover plate in an unlimited number of configurations. As described above, SMPs can be a pliable and flexible material (i.e., conforming) when the temperature of the SMP rises at or above a threshold temperature. Conversely, the SMP can be firm and non-conforming when the temperature of the SMP falls below a threshold temperature. Thus, when the SMP is above the heating threshold temperature, a user can customize the position and configuration of cover plate 320. It should be noted that SMP material may be in a non-conforming state (i.e., below a threshold temperature), but there may still be some flexibility in response to a force. However, when the force is removed, the SMP material will generally return to its original configuration in the non-conforming state. This concept can apply to all embodiments described herein and those not explicitly described but contemplated by one of ordinary skill in the art with the benefit of this disclosure.

In certain embodiments, the threshold temperature of SMP 330 can be approximately 60° C. to 80° C., however any suitable temperature can be used as would be appreciated by one of ordinary skill in the art. The operating temperature of input device 300 is typically between 0° C. to 40° C., however more robust designs may include greater temperature ranges. In some implementations, SMP deformation typically ranges from approximately +/−5 mm. Some embodiments can use other ranges (e.g., +/−3 mm, +/−8 mm, or the like). The SMP structure of FIG. 3A can accommodate significantly greater travel due to its cross-hatched lattice structure. For example, in some implementations, 35 mm can be compressed down or pulled up by 10 mm with many degrees of freedom. Thus, a user can compress frontwards, backwards, left, right, up, down, or any combination thereof. As an analogy, this can be compared to a ball joint with an extra degree of freedom (z-direction).

According to certain embodiments, input device 300 may include an internal or embedded heating system (not shown). The internal heating system can be controlled by customization control block 220, control circuit 210, or a combination thereof. The internal heating system may utilize a heating element configured to heat the SMP to a temperature at or above the heating threshold. A heating element typically converts electricity into heat by conducting an electric current through an element of a certain resistance, resulting in a heating of the element. Heating elements can use NiChrome wires, ribbons, strips, or other conducting materials like metals or carbonous compounds. Alternative embodiments may use resistance wire, molybdenum disilicide (with various dopings), screen-printed metal-ceramic tracks, etched foil, ceramics, thick film technologies, Peltier elements, or the like.

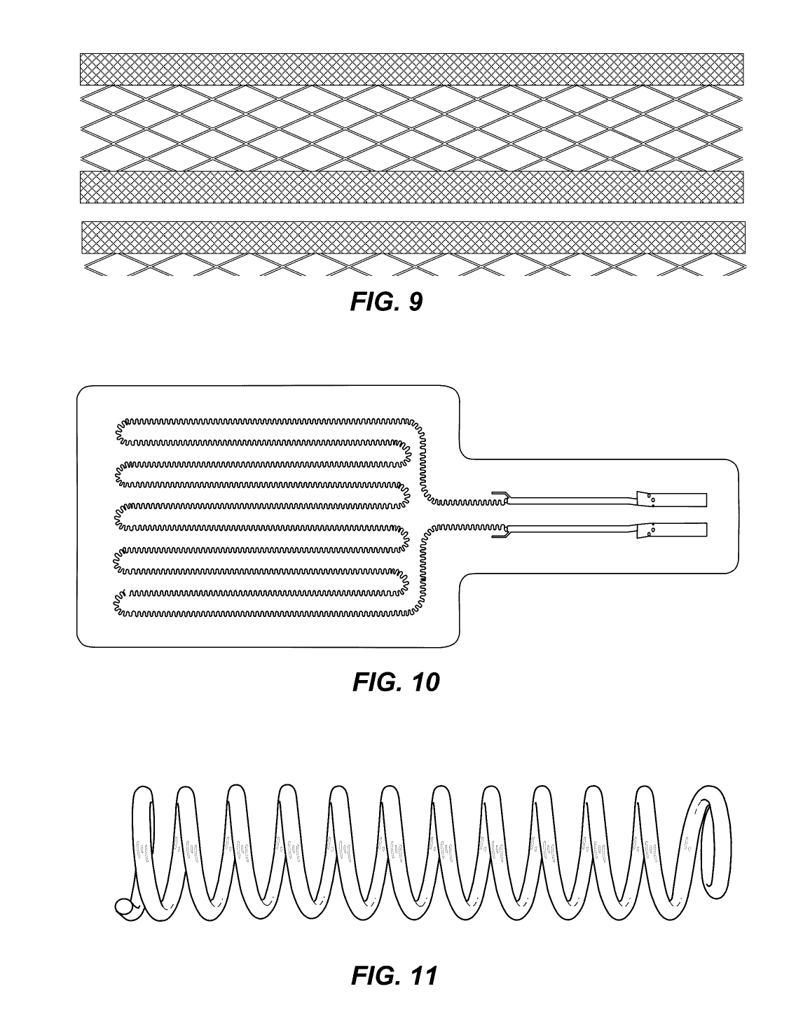

In some embodiments, the internal heating system may include a NiChrome conductive heater element mesh configured on or near the SMP portions of input device 300 to provide an even temperature distribution of the SMP surface area. In other aspects, the heating system may utilize an internal point source for applying heat to the SMP regions. Furthermore, the heated area can be made visible by thermochromatic materials at the surface. These signal the locally elevated temperature and/or the readiness for conformation. Some exemplary embodiments of internal heating systems are shown in FIGS. 9-11 and are further discussed below.

In further embodiments, external heating systems may be used to apply heat to the SMP regions (i.e., conformable region 330). For example, the SMP 330 can be heated to the heating threshold by way of hot water, a blow dryer, an open flame, or other suitable means.

Input device 300 can optionally include an SMP cooling system (not shown). For example, input device 300 may have an internal or external fan that blows air on or near the SMP to help reduce the SMP temperature below the cooling threshold.

It should be understood that the embodiments described herein are non-limiting and any combination or permutation thereof can be realized. For example, some input devices may include a number of separate SMP-coupled cover plates disposed thereon. Furthermore, the SMP-based conformable regions may be applied to any type of device including cell phones, remote controls, wrist supports, or any application where ergonomic customization would be useful.

FIG. 3B illustrates input device 300 configured to accommodate one or more SMP-coupled cover plates, according to an embodiment of the invention. Input device 300 includes housing 310, cover plate 320, and shape memory polymer (SMP) mesh 330. The SMP connection allows the cover plate to be customized in any configuration as often as desired with the application of heat beyond a threshold temperature. Input device 300 is shown in an compressed (deformed) state. Similarly, FIG. 4 is a photograph of an input device 400 with an SMP-coupled cover plate 420 also shown in a deformed state, according to certain embodiments of the invention.

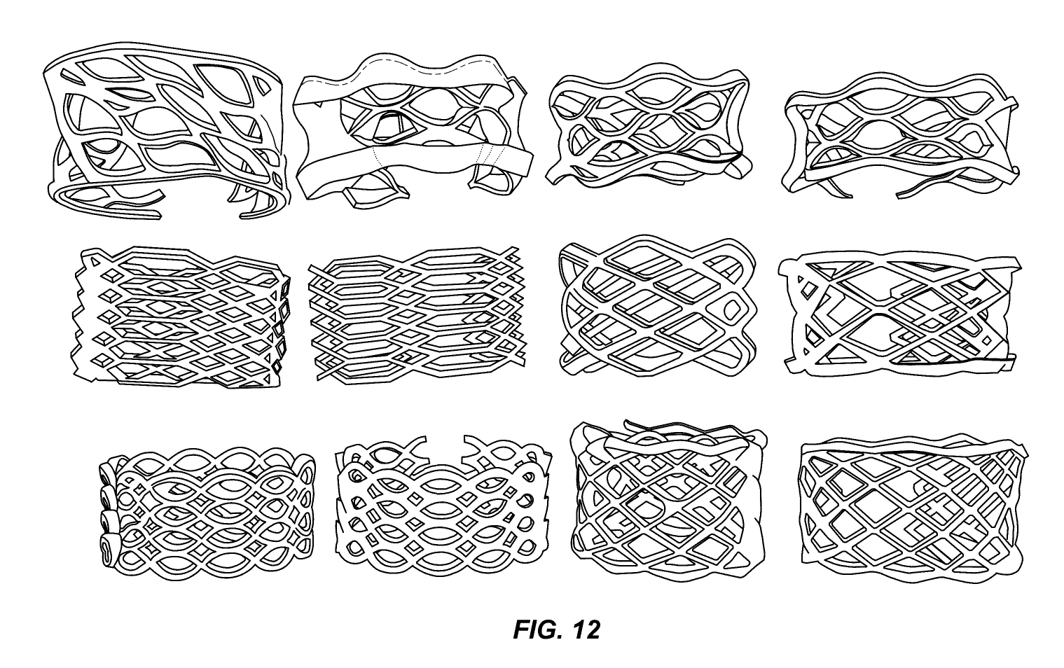

The exemplary embodiments of FIGS. 3A-3B and FIG. 4 depict SMP 330 as a cross-hatched lattice structure. It should be understood that other shapes, configurations, and patterns are possible. For instance, FIG. 3A depicts a flat, rectangular-shaped lattice structure formed into a cylinder that can be round, elliptical, or the like. Lattice structures can include any suitable cross-hatched pattern of any size or dimension. FIG. 12 shows a non-limiting assortment of lattice structures having various cross-hatched patterns, according to certain embodiments of the invention. Some lattice structures may have a uniform pattern, a non-uniform pattern, or a combination thereof. In some embodiments, the lattice structure may be a flat, rectangular design. However, the lattice structure can be any suitable shape (e.g., polygon), size, dimension, etc., as required by design. SMP 330 can have a polygonal structure (e.g., square-shaped cylinder). In some cases, SMP 330 can be a partially polygonal or cylindrical structure. For example, SMP 330 may have a gapped polygonal or cylindrical structure. Some SMP patterns may include non-lattice patterns (e.g., parallel SMP lines), asymmetric lattice patterns, or any configuration that provides a suitable deformable range, as would be appreciated by one of ordinary skill in the art with the benefit of this disclosure.

The SMP structures described herein can also be a three-dimensional (3D) printed structure, a flat structure configured into a cylindrical structure, or a combination thereof. In some cases, the SMP structure can be formed of a single coil. For example, the SMP structure can be conformable wire-like shape (having any suitable gauge) and formed, for example, into a coil with a lattice structure, as shown in FIG. 13. These embodiments can be implemented in any of the examples described herein. For instance, in some embodiments a device includes a housing, a cover plate, and a shape-memory polymer (SMP) structure disposed between the cover plate and the housing, the SMP structure being a substantially cylindrical structure having a top portion and a bottom portion. The top portion is coupled to the cover plate and the bottom portion is coupled to the housing. The cylindrical structure can be circular, oval, polygonal, or any suitable shape. As noted above, the SMP can be a three-dimensional (3D) printed structure, a flat structure configured into a cylindrical structure, flexure mechanisms or strata structures (discussed below), or a combination thereof. In some cases, the SMP structure can be formed of a single coil, as noted above and shown as a non-limiting example in FIG. 13.

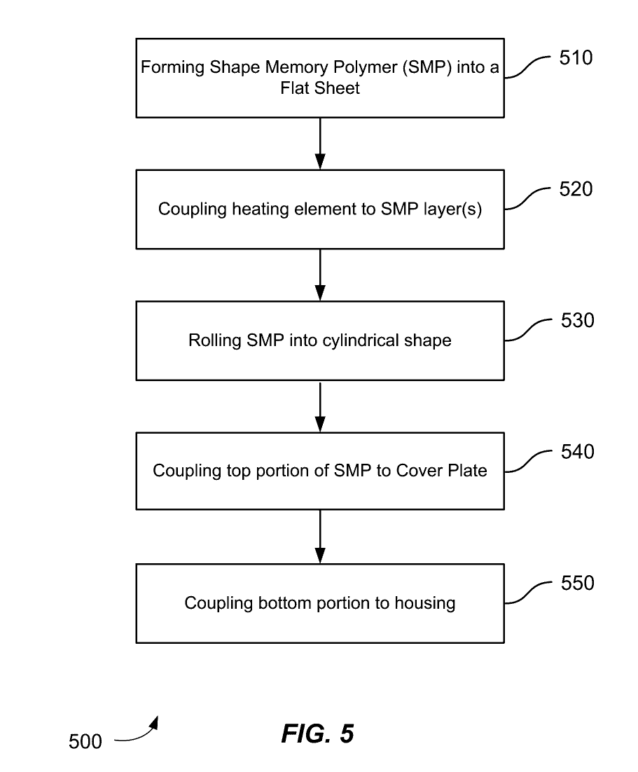

FIG. 5 is a simplified flow diagram illustrating a method 500 for forming a shape memory polymer and coupling it to an input device, according to certain embodiments of the invention. Method 500 can be a manufacturing process to provide for a highly customizable cover plate (or other conformable feature) configuration on an input device. Method 500 can be manually performed, automatically performed (e.g., assembly line or automated fabrication), or a combination thereof. In an exemplary embodiments, method 500 forms the SMP-based design of FIGS. 3A-3B.

Method 500 begins at step 510 with forming a shape memory polymer (SMP) into a flat sheet. The SMP can be a rectangular lattice structure, such as SMP 330 shown in FIGS. 3A-3B. At step 520, a heating element (not shown) is coupled to SMP 330. The heating element can control (e.g., increase) the temperature of SMP 330. For example, the heating element can change the temperature of SMP 330 above and in some cases below) the threshold temperature. The SMP can be heated by an internal or embedded heating or by an external heating source. The internal heating system can be controlled by customization control block 220, control circuit 210, or a combination thereof. For example, the control circuit can ensure that no excessive temperatures are reached. One or more temperature sensors can be used for feedback, e.g., to inform the control circuit 210 or processor of the current temperature, or to display the temperature to inform a user, etc. In some implementations, the copper trace can be used as thermometer, by measuring the change of electrical resistance as a function of temperature. An LED (light emitting diode), buzzer, or other suitable device can be used to indicate to the user that the SMP has reached a conform-ability threshold. The same process can apply to identify a suitable cooling time. The internal heating system may utilize a heating element configured to heat the SMP to a temperature at or above the heating threshold. In some cases, the heating element can use one or more of NiChrome wires, ribbons, strips, wire mesh, etched copper structures, printed heating elements on a stretchable thermoplastic polyurethane (TPU) substrate, an etched conductive (e.g., copper) substrate on a stretchable TPU substrate, a conductive and stretchable yarn, and the like, as shown and discussed below with respect to FIGS. 9-11.

In certain embodiments, the internal heating system is automatically controlled by input device 300. For example, the internal heating system may automatically turn on in response to detecting pressure (e.g., from a user's hand) or movement of input device 300. In some aspects, a user can manually implement the heating function by way of a button, type sensor, software command, etc. The implementation of an automatic internal heating system would be understood by one of ordinary skill in the art with the benefit of this disclosure.

At step 530, the SMP is rolled into a cylindrical shape. The cylindrical shape can be a complete cylinder (see FIG. 3A), or a partial cylinder. Other shapes, sizes, lattice patterns, alternative to lattice patterns, are also contemplated. In the example at hand, the cylindrical shape has a top portion and a bottom portion. The top portion and/or the bottom portion can be circular, elliptical, barrel shaped, or other suitable shape as would be appreciated by one of ordinary skill in the art.

At step 540, the top portion of SMP 330 is coupled to cover plate 320 of input device 300. At step 550, the bottom portion is coupled to housing 310 of input device 300. The cover plate and/or the housing can be formed of acrylonitrile butadiene styrene (ABS) plastic or other suitable material (e.g., plastic, rubber, metal, composite, etc.). In some embodiments, SMP 330 can be coupled to cover plate 320 and/or housing 310 by way an adhesive (e.g., glue), a mechanical connection (e.g., latches, screws, bolts, brads, tabs, etc.), or other suitable attachment means, as would be appreciated by one of ordinary skill in the art.

It should be noted that the cylindrical design formed from a flat sheet with a lattice structure is very stable and exhibits a continuous force displacement curve. Other shapes and solid or semi-solid structures may also be used, however the flat, lattice structure exhibits excellent force/deformation characteristics.

It should be appreciated that the specific steps illustrated in FIG. 5 provide a particular method of forming a shape memory polymer and coupling it to an input device, according to an embodiment of the present invention. Other sequences of steps may also be performed according to alternative embodiments. For example, alternative embodiments of the present invention may perform the steps outlined above in a different order. For instance, the integration of the heating element may take place before, during, or after the forming of the SMP into a flat sheet (step 510). Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of method 500.

Exemplary Embodiments of SMP Flexure and Strata Structures

SMP lattice structures can provide excellent deforming properties to adapt to a wide variety of preferences. However, some SMP lattice designs may exhibit non-linear force displacement behavior. For example, when a user deforms the SMP lattice structure by 1-2 mm, there may be little displacement resistance. However, displacement resistance may increase markedly and non-linearly as the SMP lattice is further deformed.

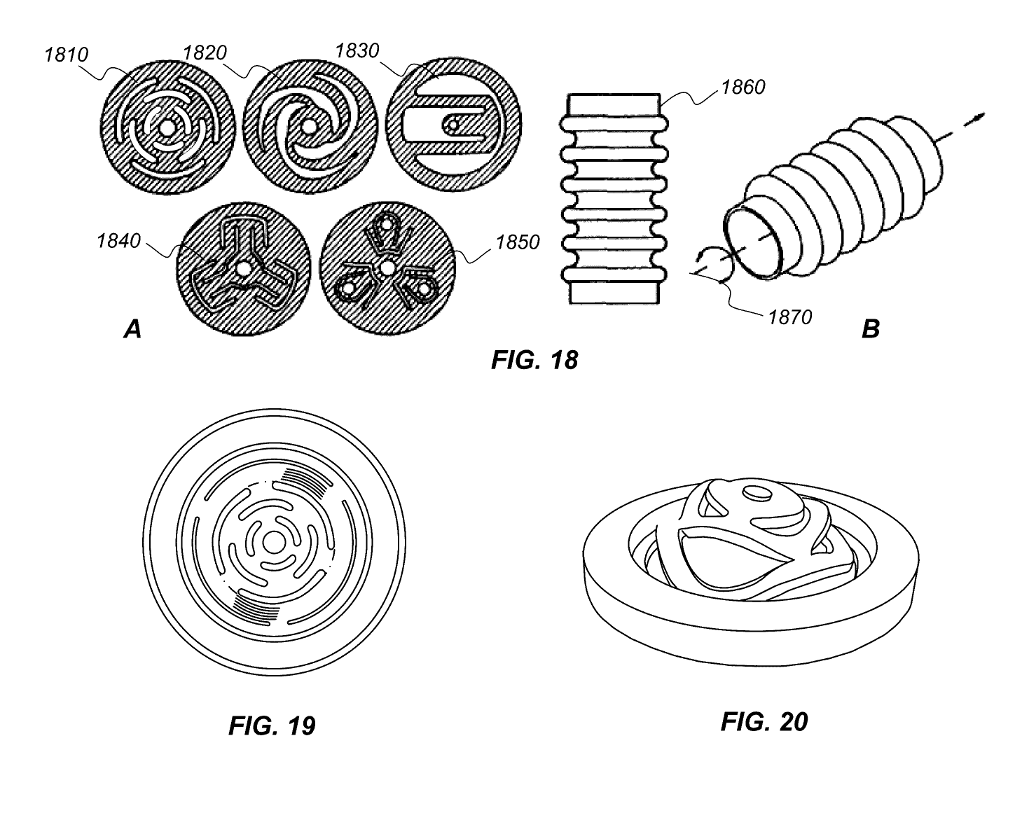

Alternative embodiments may employ SMP-based flexure mechanisms or strata structures that may be referred to generally as “flexure mechanisms.” Flexure mechanisms can have a more linear displacement curve than certain lattice structures. FIG. 18 illustrates a number of examples of SMP-based flexure mechanisms, according to certain embodiments of the invention. In some implementations, the flexure mechanisms are disk-like structures with a plurality of cutouts formed therein. The cutouts contribute to the linear displacement properties as the structure is deformed. FIGS. 19 and 20 show one example of how a flexure mechanism can be deformed. For instance, the inner portion of the flexure mechanism can be deformed in a direction normal to a plane formed by the disk-like structure. In some embodiments, the flexure mechanisms may be deformed in any direction. As described above, the SMP can be flexible and pliable (conforming) when heated to a threshold temperature, and non-conforming when the SMP temperature falls below the threshold temperature. It should be noted that the SMP may still have some flexibility in the non-conforming state (below the threshold temperature) in response to an exerted force, but when the force is removed the SMP will return to its previous configuration.

Flexure mechanisms may be used instead of, or in addition to, the SMP lattice structures described above. For example, a device may include a housing, a cover plate, and a shape-memory polymer (SMP) disposed between the cover plate and the housing where the SMP is formed in a flat disk-like structure with a plurality of cutouts therein, as described above. The disk-like structure may have an outer portion and an inner portion, and the flat disk-like structure may form a plane. The inner portion can be deformed in any direction (e.g., a direction normal to the plane) and coupled to the cover plate, and the bottom portion can be coupled to the housing. The cover plate can be a palm plate, side plate, knuckle plate, finger plate, or any covering on an input device. The cover plate can be configured in any orientation due to the conforming properties of the SMP flexure mechanism, as discussed above with respect to the SMP lattice structures, and as would be appreciated by one of ordinary skill in the art.

Flexure mechanism may employ any suitable cutout pattern that preferably provides a linear displacement curve. Referring to FIG. 18, some of the cutout patterns include a partial concentric circle pattern 1810, a spiral pattern 1820, and a number of symmetrical patterns (1830, 1840, 1850). Other patterns (e.g., symmetrical or asymmetrical) are contemplated and would be appreciated by one of ordinary skill in the art.

The cutouts can be formed during or after the manufacturing of the disk-like structures. For instance, they can be cut out from a solid mold. In some cases, the flexure mechanisms may be formed with a three-dimensional printing process such that the cutouts are formed at the same time that the disk-like structure is formed. The disk-like structure may be formed in other shapes as well. For instance, the disk-like structure may be shaped like an oval, square, rectangle, or other suitable symmetrical or asymmetrical polygonal shape of any size, thickness, or dimension.

Some shapes may not be disk-like. Flexure mechanism 1860 shows an SMP-based collapsible tube structure that may be deformed by compressing or extending the SMP along axis 1870 when the SMP is heated above its threshold temperature. Any of the flexure mechanisms shown or described herein can be used in the same manner as the SMP lattice structures described above. For example, an input device can include a housing, a cover plate, and a shape-memory polymer (SMP) structure disposed between the cover plate and the housing, where the SMP structure formed in a collapsible tube-structure having an upper portion and a lower portion. The upper portion can be coupled to the cover plate, and the bottom portion can be coupled to the housing. The cover plate can be a palm plate, side plate, knuckle plate, finger plate, or any covering on an input device.

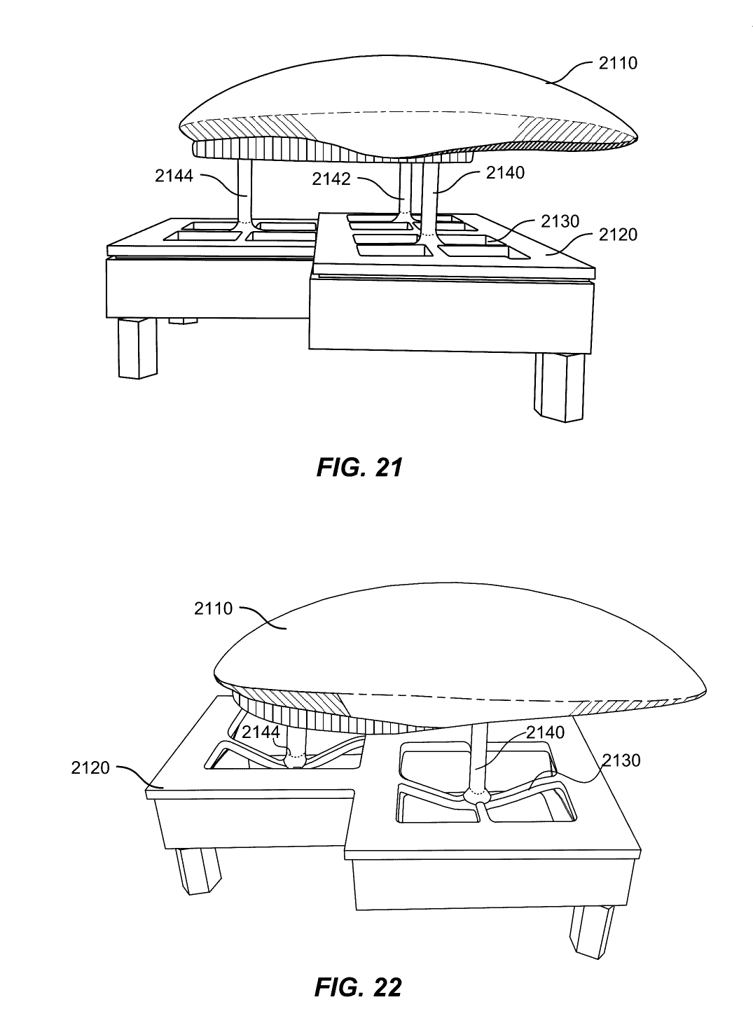

FIGS. 21-22 show a prototype flexure mechanism strata structure, according to certain embodiments of the invention. The prototype shows a cover plate 2110 (i.e., a palm plate, in this case) with support structures 2140, 2142, 2144 coupled to the bottom surface of cover plate 2110. This particular prototype shows three support structures, but any number of support structures may be used. The support structures are shown as vertically protruding posts with an angle substantially normal to the bottom surface of the cover plate (i.e., approximately 90 degrees), however other types of support structures of any size or shape and configured in any angle may be used (e.g., posts, walls, wedges, etc.). The support structures are coupled to a platform 2120 having a top surface with a cavity formed therein. A shape memory polymer (SMP) structure 2130 is suspended over the cavity. In this case, SMP structure 2130 is configured as two SMP bands (strata structures) crossing the cavity and intersecting at the center of the cavity. Other configurations are contemplated including more or fewer bands, bands of different lengths, thicknesses, widths, and different crossing configurations (e.g., parallel patterns, cross-hatched patterns, symmetric patterns, asymmetric patterns, etc.). The support structures are coupled to the intersection of the two SMP structures. Other locations for coupling the support structures to SMP structure(s) 2130 are possible (e.g., near the corners, multiple support structures on the same SMP structure, etc.). It should be noted that FIGS. 21-22 show a prototype and that the SMP implementation described herein can be applied to any input device, handheld device, etc., as described above with respect to the SMP lattice structure embodiments (e.g., FIGS. 3A-5 and 12). For instance, the platform 2120 may be an internal structure disposed in or on a computer mouse, computer keyboard, or any other device described herein.

As shown in the transition from FIG. 21 to FIG. 22, cover plate 2110 moves downward as the SMP structures 2130 deform in response to an applied force to the top of cover plate 2110. That is, crossing strata structure 2130 is bowing under each support structure such that the orientation and configuration of cover plate 2110 is changed (i.e., customized). SMP structures 2130 (and SMP structures, in general) can be configured to be conformable (deformed) in response to a force when they reach a threshold temperature and maintain a deformed configuration when the temperature drops below the threshold temperature. SMP-based strata structures, flexure mechanisms, etc., are conformable and configurable as described above with respect to SMP structures generally, as would be appreciated by one of ordinary skill in the art.

In some implementations, SMP strata structures can be applied to an input device. For instance, a device may include a housing, a cover plate having a top surface and a bottom surface, and a support structure having a first end and a second end. The first end of the support structure can coupled to the bottom surface of the cover plate, and the support structure can protrude at an angle substantially normal to the bottom surface of the cover plate. The device can further includes a platform disposed in the housing, with the platform having a top surface with a cavity formed therein. A shape-memory polymer (SMP) structure can be coupled to the top surface of the platform, where a portion of the SMP structure is suspended over and crosses the cavity (e.g., see FIGS. 21-22). The second end of the support structure can be coupled to the suspended portion of the SMP structure.

Some embodiments can include a second SMP structure coupled to the top surface of the platform, where a portion of the second SMP structure is suspended over and crosses the cavity such that both SMP structures intersect over the cavity (e.g. see, FIGS. 21-22), and where the second end of the support structure is coupled to the SMP structure at the intersection of both SMP structures. In any case, SMP structures (e.g., lattice structures, 3D printed structures, flexure mechanisms, strata structures, etc.), can be conformable (conforming) at temperatures at or above a threshold temperature and non-conforming at temperatures below the threshold temperature. It should be understood that although an SMP structure may be in a non-conforming state, there still can be some flexibility in response to a force. However, when the force is removed, the SMP material will generally return to its original configuration in the non-conforming state. For example, if a cover plate on an input device is configured to be bowed forward and skewed left when the SMP link (e.g., SMP lattice structure, 3D printed structure, flexure mechanism, etc.) coupling the cover plate to a structure in the input device is raised to a temperature above a threshold temperature and subsequently cooled, the bowed and skewed configuration will be set. If a user applies force and attempts to move the cover plate back to its original position (i.e., no bowing or skewing), the SMP material may flex and allow the cover plate move in that direction (partially or entirely), but the cover plate will return to its forward bowed and skewed orientation after the force is removed or reduced.

Deformation and Mechanical Effects

Shape customization allows the user to define a preferred shape within certain boundaries. Each user has a set of physiological characteristics and personal preferences. For example, there are both right handed and left handed users, differing hand sizes, grip styles, and the like. In order to accommodate for the myriad possibilities, a large deformation range is needed.

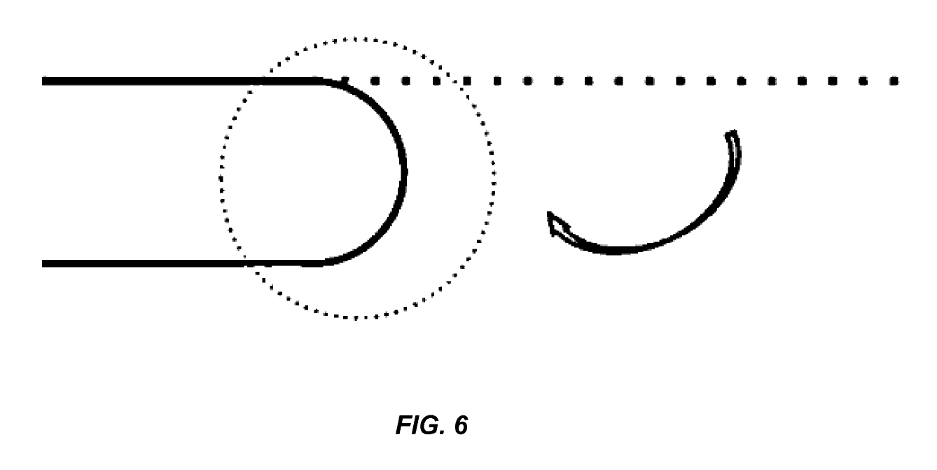

When a structure is deformed, there are both macroscopic and microscopic deformations. Macroscopic deformations are typically perceived by the user, while microscopic deformations are not. To illustrate these two concepts, consider that a 100 mm thread pulled by 1 mm undergoes 1% of strain. In another example, a sheet of paper being bent 180 degrees undergoes enormous “deformation” from the user perspective (macroscopic deformation), while the material itself experiences very little strain (e.g., see FIG. 6). FIG. 6 illustrates a simplified diagram showing a macroscopic deformation of a sheet of paper. Here, the sheet of paper that is being bent appears to exhibit enormous “deformation” to the bender, but the material itself actually experiences very little strain at the microscopic level.

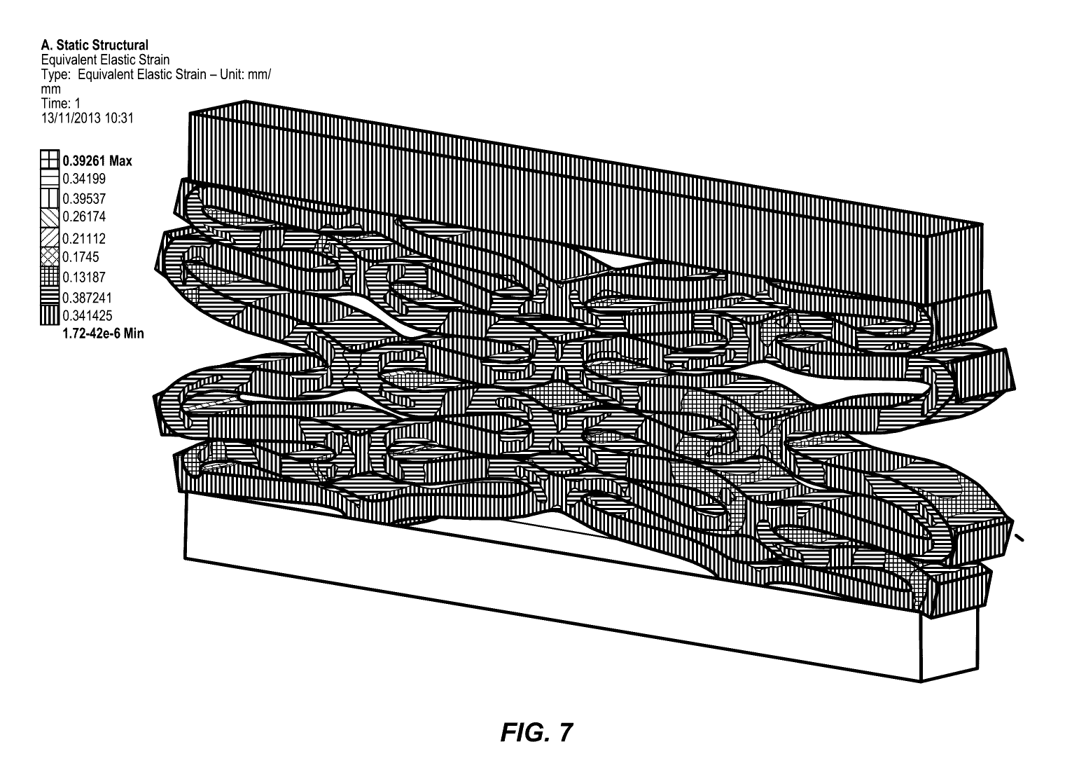

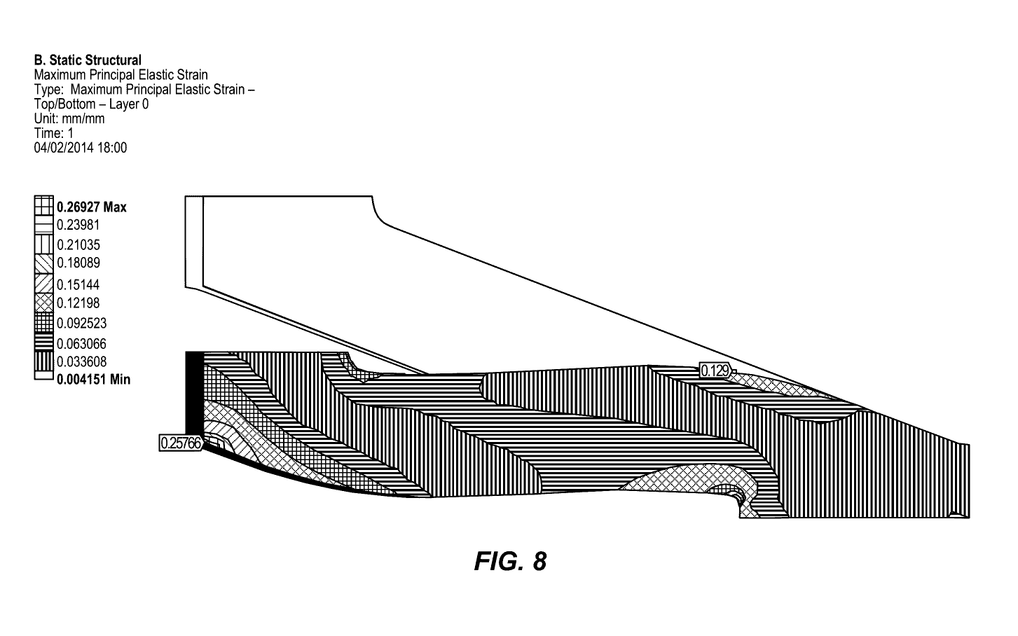

In the SMP lattice structure this principle applies. The deformation that is apparent to the user can be quite large and reach 100%. However, the strain on the material may only be about 10%. This means that the structure can be significantly deformed on a macroscopic scale, with no damage to the material at a microscopic level (10% strain). In another example, a 10 mm macroscopic compression of the lattice structure of FIG. 3A-3B (i.e., about 25% of the total height) amounts to about a 5-10% compression at a microscopic level. Accordingly, many significant SMP deformations can be performed without damaging its lattice structure or shape deforming capabilities. FIGS. 7-8 illustrate the results of a mechanical simulation where the strain experienced by the material is visualized on a color scale.

Internal SMP Heating Structures

A heating element can control (e.g., increase) the temperature of a shape memory polymer (SMP). Any heating element used to activate the shape memory effect has to allow the stretching deformation. While flexible (bendable) heating elements are quite common, stretchable heating elements are not. This is primarily due to the fact that metals can be stretched less than 1% before breaking. However, metal can have the necessary conductivity to act as a heating element for the electrical configuration (5-10 W at 3-5V). Stretchable heating elements can be 2D (e.g., FIG. 10) or 3D springs (e.g., FIG. 11) with or without a substrate. They can also consist of special conductive ink blends printed on a stretchable substrate, like TPU or directly on the SMP (e.g., FIG. 9). A good example of a 2D spring is an etched copper structure in snake shape on a TPU substrate. 3D springs can either be mechanical springs or filaments that are wound around an elastic core material.

The integration of the heating element into the SMP can be very challenging. Gluing, laminating insert molding, transfer molding, or Laser Direct Structuring are options that can be used. One parameter is the homogenous heating which implies a well defined heating element and a good integration into the SMP. The heating element should have a regular and constant heat output without any localized hot or cold spots and the heat should be readily transferred to the SMP by eliminating insulating air.

The SMP can be heated by an internal or embedded heating or by an external heating source. An internal heating system can be controlled by customization control block 220, control circuit 210, or a combination thereof. For example, the control circuit can set the temperature to the threshold temperature to allow the user to deform the SMP to a desired configuration. The control circuit can regulate maximum and minimum limits such that no excessive temperatures are reached. In some implementations, a timer is used to determine an optimal heat time and provide a security time out for excessive heat or time conditions. One or more temperature sensors can be used for feedback, e.g., to inform the control circuit 210 or processor of the current temperature, or to display the temperature to inform a user, etc. Furthermore by monitoring the electrical properties of the copper heating element the temperature can be deduced. An LED (light emitting diode), buzzer, or other suitable device can be used to indicate to the user that the SMP has reached a deformable state. The same process can apply to identify a suitable cooling time. The internal heating system may utilize a heating element configured to heat the SMP to a temperature at or above the heating threshold. In some cases, the heating element can use one or more of NiChrome wires, ribbons, strips, wire mesh, etched copper structures, printed heating elements on a stretchable thermoplastic polyurethane (TPU) substrate, an etched conductive (e.g., copper) substrate on a stretchable TPU substrate, a conductive and stretchable yarn, and the like, as discussed below.

As discussed above, shape memory polymers may get soft and malleable at temperatures above 70° C. (i.e., the threshold temperature). There are different ways that the material's temperature can be increased. External ways of heating, like an oven or water bath are typically excluded due to safety concerns. However, an internal heating element is subject to the same deformation as the structure. Therefore, an internal heating element must be stretchable and able to withstand the deformations applied to the SMP material. Unfortunately, stretchiness and electrical conductivity (metals) are not conventionally compatible concepts. The following embodiments achieve both stretchiness and conductivity in a compact design. Typically, heating time may be about 30 seconds to a minute.

FIG. 9 is a printed heating element on a stretchable non-conductive substrate, according to certain embodiments of the invention. The heating element is formed as a flat, rectangular lattice structure that couples to the surface of the SMP can be configured in a cylindrical shape. The printed heating element is disposed on a non-conductive substrate (e.g., TPU). It should be noted that other sizes, dimensions, patterns, conductive inks, and conductive particulates are possible. The heating element of FIG. 9 can be internally integrated in the SMP-based input device, coupled to the SMP section(s), and configured to heat the SMP as current is passed through it. Since the heating element is stretchable, it can withstand the deformations applied to the SMP. The printed heating element is comprised of a conductive ink, which can have good stretch properties. The conductive ink may be formed of a density of conductive particulates. The density of conductive particulates can vary widely and would be known and appreciated by one of ordinary skill in the art. The conductive particulates can be pad printed, screen printed, sprayed on, sputtered, etc., and may be comprised of any suitable conductive element, alloy, compound, or the like (e.g., copper, gold, aluminum). A flat, rectangular lattice structure is shown in FIG. 9, however different shapes and thicknesses are possible (e.g., squares, triangles, circular shapes, etc.). The lattice of FIG. 9 is shown in a uniform cross-hatched pattern. Uniform and non-uniform lattice structures can be used. In some cases, non-lattice structures can be used. The printed heating element has to be tuned in a way to have an overall resistance in order to meet the total output power (5-10 W) for the given potential (3-5V). At the same time this power output has to be distributed homogeneously. To meet these two requirements it may be necessary to have one or several parallel conducting traces. The conducting traces can have a regular or non-regular width.

FIG. 10 is an etched conductive substrate on a non-conductive substrate, according to certain embodiments of the invention. Some conductors, like copper, are not very stretchable. However, when etched into very fine structures, such as two-dimensional springs, a suitable yield elongation can be achieved. FIG. 10 shows a two-dimensional heating element having two leads and a serpentine spring-like pattern. Different layout and spring patterns are possible. The etched substrate can be a stretchable TPU substrate or other suitable material with similar stretching properties. The heating element of FIG. 10 can be internally integrated in the SMP-based input device, coupled to the SMP section(s), and configured to heat the SMP as current is passed through it. Since the heating element is stretchable, it can withstand the deformations applied to the SMP. The etched conductor can be any suitable conductive element, alloy, compound, or other material, as would be appreciated by one of ordinary skill in the art.

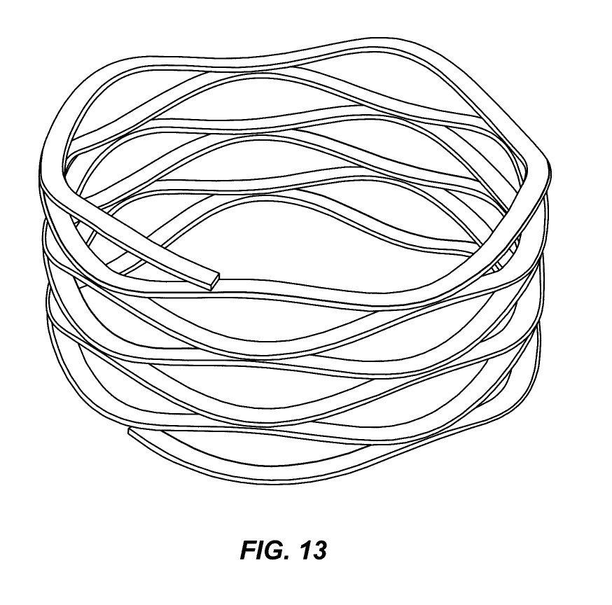

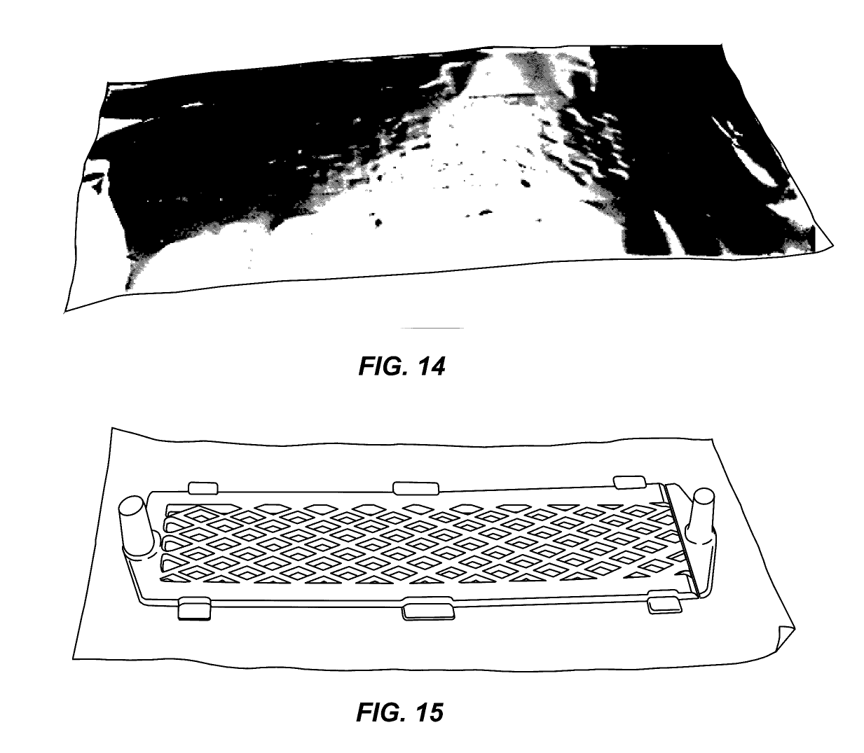

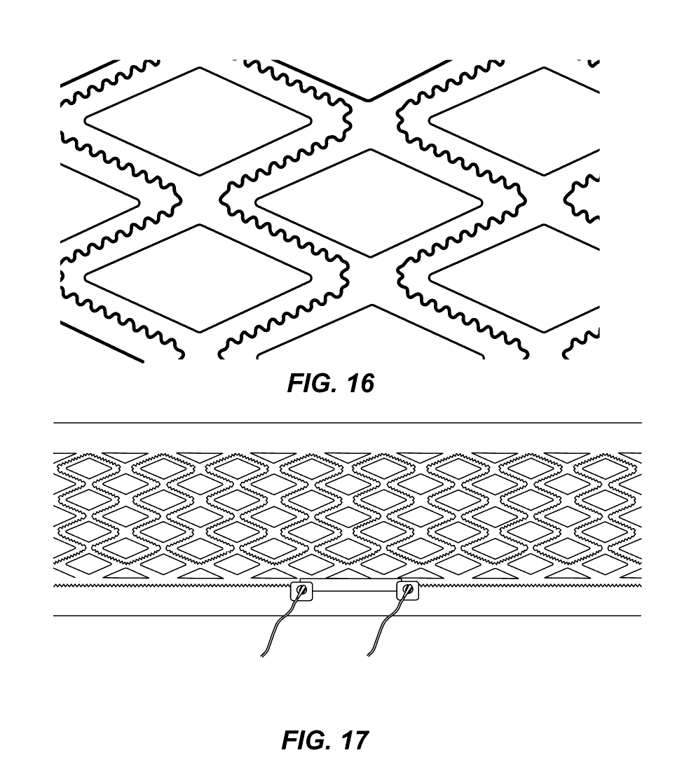

In certain embodiments, the heating element can also be etched directly on the SMP. FIGS. 14-17 provide examples of heating elements being etched directly on SMP, according to certain embodiments of the invention. In FIG. 14, the SMP structure is casted on a copper sheet and standard PCB processes are used to remove all the copper that is not required. Another process to get a copper structure on the SMP is Laser Direct Structuring. The SMP contains small particles that can be activated by laser and then copper is plated in a secondary operation.

FIG. 11 is a conductive and stretchable yarn formed into a three-dimensional coil structure, according to certain embodiments of the invention. The stretchable yarn is formed into the coil like a spring around a central yarn. It should be understood that different dimensions of the spring are anticipated and may depend on the dimensions of the SMP that it is coupling to. In some implementations, the yarn can be integrated during the casting process or in a secondary operation when the part geometry is already fixed.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, SMP lattice structures, flexure mechanisms, strata structures, structures not specifically illustrated, and combinations thereof can be applied to any of the implementations and, in some cases, interchangeably, as would be appreciated by one of ordinary skill in the art with the benefit of this disclosure.

Preferred embodiments of this disclosure are described herein. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A device comprising:
a housing;
a cover plate; and
a shape-memory polymer (SMP) disposed between the cover plate and the housing, the SMP being a substantially rectangular flat lattice structure formed into a cylinder, the cylinder having a top portion and a bottom portion,
wherein the top portion is coupled to the cover plate, and
wherein the bottom portion is coupled to the housing.

2. The device of claim 1 wherein the top portion is circular or elliptical, and
wherein the bottom portion is circular or elliptical.

3. The device of claim 1 wherein the SMP is conformable at temperatures at or above a threshold value, and wherein the SMP is non-conformable at temperatures below the threshold value.

4. The device of claim 1 further comprising a heating element configured to control the temperature of the shape memory polymer.

5. The device of claim 3 wherein the heating element is coupled to the SMP and is comprised of one of:
a conductive ink formed of a density of conductive particulates;
an etched conductor structure having a two-dimensional spring configuration formed on a non-conductive substrate; or
a conductive and stretchable yarn formed into a coil structure.

6. The device of claim 1 wherein the cover plate is one of:
a palm plate;
side plate;
knuckle plate; or
finger plate.

7. A device comprising:
a housing;
a palm rest; and
a shape-memory polymer (SMP) disposed between the palm rest and the housing, the SMP being a substantially rectangular flat lattice structure formed into a cylinder, the cylinder having a top portion and a bottom portion.

8. The device of claim 7 wherein the top portion is circular or elliptical and is coupled to the palm rest, and wherein the bottom portion is circular or elliptical and coupled to the housing.

9. The device of claim 7 wherein the SMP is conformable at temperatures at or above a threshold value, and wherein the SMP is non-conformable at temperatures below the threshold value.

10. The device of claim 7 further comprising a heating element configured to control the temperature of the shape memory polymer.

11. The device of claim 10 wherein the heating element is coupled to the SMP and is comprised of one of:
a conductive ink formed of a density of conductive particulates;
an etched conductor structure having a two-dimensional spring configuration formed on a non-conductive substrate; or
a conductive and stretchable yarn formed into a coil structure.

12. A method comprising:
forming a shape memory polymer (SMP) into a flat sheet;
rolling the shape memory polymer into cylindrical shape, the SMP cylindrical shape having a top portion and a bottom portion;
coupling top portion to a first component of a device; and
coupling the bottom portion to a second component of the device.

13. The method of claim 12 wherein the top portion is coupled to the first component via an adhesive or retaining device, and wherein the bottom portion is coupled to the second component via an adhesive or retaining device.

14. The method of claim 12 further comprising coupling a heating element to the SMP, wherein the heating element controls the temperature of the shape memory polymer.

15. The method of claim 14 wherein the SMP and is comprised of one of:
a conductive ink formed of a density of conductive particulates;
an etched conductor structure having a two-dimensional spring configuration formed on a non-conductive substrate; or
a conductive and stretchable yarn formed into a coil structure.

16. A device comprising:
a housing;
a cover plate; and
a shape-memory polymer (SMP) structure disposed between the cover plate and the housing, the SMP being a substantially cylindrical structure having a top portion and a bottom portion,
wherein the top portion is coupled to the cover plate, and
wherein the bottom portion is coupled to the housing

17. A device comprising:
a housing;
a cover plate; and
a shape-memory polymer (SMP) disposed between the cover plate and the housing, the SMP formed in a flat disk-like structure and having a plurality of cutouts therein, the disk-like structure having an outer portion and an inner portion, and the flat disk-like structure forming a plane,
wherein the inner portion is deformed in a direction normal to the plane and coupled to the cover plate, and
wherein the bottom portion is coupled to the housing.

18. A device comprising:
a housing;
a cover plate; and
a shape-memory polymer (SMP) structure disposed between the cover plate and the housing, the SMP structure formed in a collapsible tube-structure having an upper portion and a lower portion,
wherein the upper portion is coupled to the cover plate, and
wherein the bottom portion is coupled to the housing.

19. A device comprising:
a housing;
a cover plate having a top surface and a bottom surface;
a support structure having a first end and a second end, the first end coupled to the bottom surface of the cover plate, the support structure protruding at an angle substantially normal to the bottom surface of the cover plate;
a platform disposed in the housing, the platform having a top surface, and the top surface of the platform having a cavity formed therein; and
a shape-memory polymer (SMP) structure coupled to the top surface of the platform, wherein a portion of the SMP structure is suspended over and crosses the cavity,
wherein the second end of the support structure is coupled to the suspended portion of the SMP structure.

20. The device of claim 28 further comprising a second SMP structure coupled to the top surface of the platform, wherein a portion of the second SMP structure is suspended over and crosses the cavity such that both SMP structures intersect over the cavity, and wherein the second end of the support structure is coupled to the SMP structure at the intersection of both SMP structures.
